(19) United States
(12) Patent Application Publication
(10) Pub. No.: US 2025/0095246 A1
(43) Pub. Date: Mar. 20, 2025

(54) SYSTEMS AND METHODS FOR GENERATING IMAGES USING DIFFUSION MODEL

(71) Applicant: WOVEN BY TOYOTA, INC., Tokyo (JP)

(72) Inventor: Koichiro YAMAGUCHI, Tokyo (JP)

(73) Assignee: WOVEN BY TOYOTA, INC., Tokyo (JP)

(21) Appl. No.: 18/468,046

(22) Filed: Sep. 15, 2023

(51) Int. Cl. G06T 11/60; G06T 5/00; G06T 7/194; G06T 7/50; G06T 7/73

(52) U.S. Cl. CPC G06T 11/60; G06T 5/77; G06T 7/194; G06T 7/50; G06T 7/73; G06T 2207/20021; G06T 2207/20081; G06T 2207/20092; G06T 2207/30242

(57) ABSTRACT

Provided are a method, system, and device for generating synthetic images. The method may include, receiving an input image; removing at least one pre-existing object from the input image; inpainting the region where the at least one pre-existing object was removed; estimating a position of another pre-existing object from the input image; generating a layout over the input image based on the estimated position; and generating a synthetic object based on the layout.

Systems and methods consistent with example embodiments of the present disclosure relate to generating images using a diffusion model.

### BACKGROUND

Machine learning (ML) models may be used to automate a variety of tasks. When developing an ML model, the developer may need to ensure the functionality and accuracy of the ML model. For example, in the context of a ML model for use in a self-driving vehicle, the developer may need to ensure that the ML model can accurately detect objects (such as an oncoming vehicle), and choose the correct responsive option for the self-driving vehicle. To this end, the developer may need a large amount of test data (i.e., so that the accuracy of the ML model can be affirmed to a certain metric), and particularly in this context, images may be used as either training or testing data.

It may be difficult for the developer to readily have access to a large amount of high quality images as training/testing data for a machine learning model (e.g., object detection or computer vision AI model). In particular, while methods exist in the prior art for generating synthetic images (e.g., diffusion model), the quality of such images as training/testing data cannot be ascertained. Further, much manual tasks are required to generate image datasets using diffusion models. For example, the developer may need to spend a lot of time to input conditions and parameters in order to generate diverse images for the dataset, and may need to check through all the generated images to select ones which are appropriate, or search other sources for images. This may be very time consuming. Accordingly, there is a need for an improved method for generating synthetic images for use as testing/training data in ML models.

### SUMMARY

According to one or more example embodiments, apparatuses and methods provide a process for generating diverse image data for use in training/testing machine learning (ML) models. According to an embodiment, a method may include initially receiving an input image (which may have been generated by means such as a diffusion model). Unwanted objects (such as foreground objects) may be removed (for example, by means such as instance segmentation). The removed areas may be inpainted to fill in the empty space. The location of another object may be estimated, in order to generate a layout, which may be overlayed with the input image. The layout may then be used to determine and generate a synthetic object. Accordingly, such a method may be repeated over a large amount of input images, (even if the quality of the input images is not perfect), thereby generating a large amount of high quality images for use in training/testing the ML models.

According to embodiments, a method may be provided for generating a synthetic image. The method may include: receiving an input image; removing at least one pre-existing object from the input image; inpainting the region where the at least one pre-existing object was removed; estimating a position of another pre-existing object from the input image; generating a layout over the input image based on the estimated position; and generating a synthetic object based on the layout.

The at least one pre-existing object may be a foreground object, and the another pre-existing object may be a road structure object; and the generated synthetic object may be a vehicle.

Estimating a position of the another pre-existing object may include: estimating the depth of the road structure object. The another pre-existing object may be a road lane, and estimating a position of the another pre-existing object may further comprise: estimating the location of the road lane. Removing the at least one object may be performed by instance segmentation.

According to one or more example embodiments, apparatuses and methods provide provide a process for generating diverse image data for use in training/testing machine learning (ML) models. In particular, apparatuses and methods consistent with the inventive concept(s) provide a process of generating image data using a diffusion model(s) based on one or more conditions (e.g., user-input conditions). By way of example, a method of generating image data (e.g., training or testing image dataset for training or testing an AI/ML model such as a computer vision or object detection model used in an autonomous driving machine (e.g., ego-vehicle)) according to an example embodiment may generate images of a particular scene configuration based on one or more conditions input by a user (e.g., motorbike at back of a truck, three people crossing a road, etc.). Further, a method of generating image data according to an example embodiment may generate a large training/testing image dataset based on a user-input distribution of objects, such as a user input distribution of distances of cars (e.g., non-ego vehicles) to the camera perspective (e.g., ego-vehicle) (e.g., 30%<20 m, 50%>=20 m, 20%>60 m).

According to embodiments, a method for generating a synthetic image using a diffusion model may be provided. The method may include obtaining road data; determining a location of one or more objects relative to the road data, based on one or more input parameters; projecting one or more object bounding boxes, corresponding to the one or more objects, on an image plane based on the determined location, the image plane being from a perspective of a camera; and generating an image using a diffusion model based on a layout of the one or more object bounding boxes.

The road data may be automatically generated based on location parameters input by a user or randomly determined.

Determining the location of the one or more objects comprises determining, based on the one or more input parameters, at least one of a number and object type of the one or more objects.

The one or more input parameters comprises at least one of a number of the one or more objects, an object type, information on a position relative to an ego-vehicle, location information for road data, and information on one or more relationships between objects.

Generating the image comprises generating, using the diffusion model, a plurality of images based on the layout.

Additional aspects will be set forth in part in the description that follows and, in part, will be apparent from the description, or may be realized by practice of the presented embodiments of the disclosure.

### BRIEF DESCRIPTION OF THE DRAWINGS

Features, aspects and advantages of certain exemplary embodiments of the disclosure will be described below with reference to the accompanying drawings, in which like reference numerals denote like elements, and wherein:

FIG. 1 is a diagram of example components of a device according to an example embodiment;

FIG. 2 is a flowchart diagram showing a method for generating a synthetic image by removing an unwanted object and generating a new synthetic object according to one or more example embodiments;

FIG. 3 is a flowchart diagram showing a method for generating an image based on road data using a diffusion model and bounding boxes according to one or more example embodiments;

FIG. 4 is a flowchart diagram showing a method for generating a synthetic image based on a layout according to one or more example embodiments; and

FIG. 5 is a flowchart diagram showing a method for generating a synthetic image using a diffusion model according to one or more example embodiments.

### DETAILED DESCRIPTION

The following detailed description of example embodiments refers to the accompanying drawings. The disclosure provides illustration and description, but is not intended to be exhaustive or to limit one or more example embodiments to the precise form disclosed. Modifications and variations are possible in light of the disclosure or may be acquired from practice of one or more example embodiments. Further, one or more features or components of one example embodiment may be incorporated into or combined with another example embodiment (or one or more features of another example embodiment). Additionally, in the flowcharts and descriptions of operations provided herein, it is understood that one or more operations may be omitted, one or more operations may be added, one or more operations may be performed simultaneously (at least in part), and the order of one or more operations may be switched.

It will be apparent that example embodiments of systems and/or methods and/or non-transitory computer readable storage mediums described herein may be implemented in different forms of hardware, firmware, or a combination of hardware and software. The actual specialized control hardware or software code used to implement these systems and/or methods is not limiting of one or more example embodiments. Thus, the operation and behavior of the systems and/or methods and/or non-transitory computer readable storage mediums are described herein without reference to specific software code. It is understood that software and hardware may be designed to implement the systems and/or methods based on the descriptions herein.

Even though particular combinations of features are recited in the claims and/or disclosed in the specification, these combinations are not intended to limit the disclosure of possible example embodiments. In fact, many of these features may be combined in ways not specifically recited in the claims and/or disclosed in the specification. Although each dependent claim listed below may directly depend on only one claim, the disclosure of possible example embodiments includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

The term “software part”, as used herein refers to an individual component or unit of software which may implement one or more feature(s). These software parts may be dependent on other software parts. A plurality of software parts which have the same software part type may also be provided. Specifically, a software part type may indicate what the software part is intended for (e.g., SDK, integration, for system testing, etc.). Each of these software part types may have standards (for example, ISO standards) which need to be passed in order for the software part to pass a specific developmental stage (for example, a coverage stage in which the user is still intending to collect and evaluate code coverage metrics only). These standards may be evaluated in terms of metrics. According to some embodiments, each software part may have an identifier including, but not limited to, a version number and a feature name.

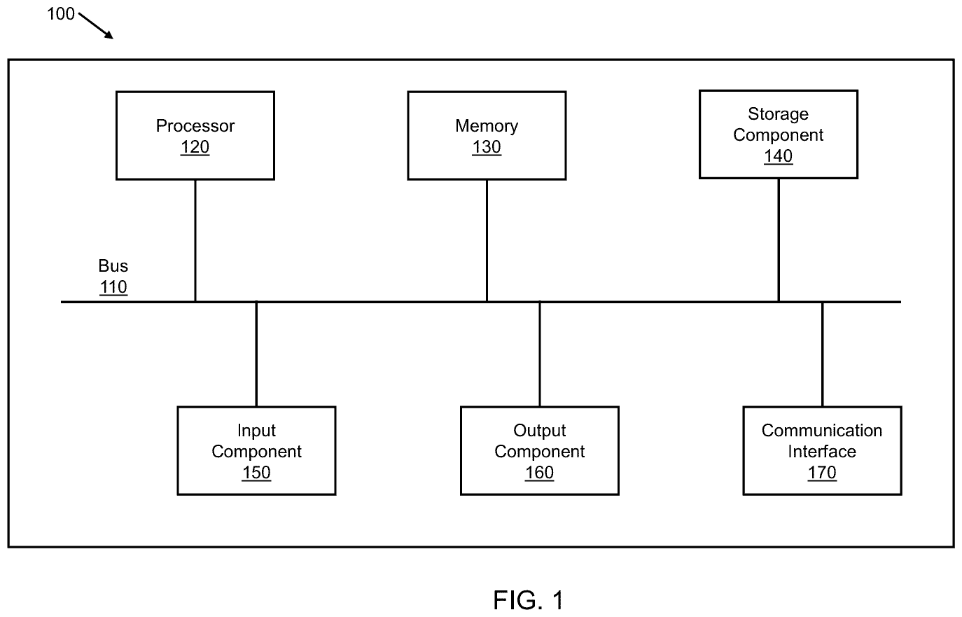

FIG. 1 is a diagram of example components of a image synthesization device 100. As shown in FIG. 1 image synthesization device 100 may include a bus 110, a processor 120, a memory 130, a storage component 140, an input component 150, an output component 160, and a communication interface 170.

Bus 110 includes a component that permits communication among the components of image synthesization device 100. The processor 120 may be implemented in hardware, firmware, or a combination of hardware and software. Processor 120 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In one or more example embodiments, the processor 120 includes one or more processors capable of being programmed to perform a function. The memory 130 includes a random access memory (RAM), a read only memory (ROM), and/or another type of dynamic or static storage device (e.g., a flash memory, a magnetic memory, and/or an optical memory) that stores information and/or instructions for use by the processor 220.

Storage component 140 stores information and/or software related to the operation and use of image synthesization device 100. For example, the storage component 140 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive. Input component 150 includes a component that permits image synthesization device 100 to receive information, such as via user input (e.g., a touch screen display, a keyboard, a keypad, a mouse, a button, a switch, and/or a microphone). Additionally, or alternatively, input component 150 may include a sensor for sensing information (e.g., a global positioning system (GPS) component, an accelerometer, a gyroscope, and/or an actuator). Output component 160 includes a component that provides output information from image synthesization device 100 (e.g., a display, a speaker, and/or one or more light-emitting diodes (LEDs)).

The communication interface 170 includes a transceiver-like component (e.g., a transceiver and/or a separate receiver and transmitter) that enables image synthesization device 100 to communicate with other devices, such as via a wired connection, a wireless connection, or a combination of wired and wireless connections. The communication interface 170 may permit the image synthesization device 100 to receive information from another device and/or provide information to another device. For example, the communication interface 170 may include, but is not limited to, an Ethernet interface, an optical interface, a coaxial interface, an infrared interface, a radio frequency (RF) interface, a universal serial bus (USB) interface, a Wi-Fi interface, a cellular network interface, or the like.

The image synthesization device 100 may perform one or more example processes described herein. According to one or more example embodiments, the image synthesization device 100 may perform these processes in response to the processor 120 executing software instructions stored by a non-transitory computer-readable medium, such as the memory 130 and/or the storage component 140. A computer-readable medium is defined herein as a non-transitory memory device. A memory device includes memory space within a single physical storage device or memory space spread across multiple physical storage devices.

Software instructions may be read into the memory 130 and/or the storage component 140 from another computer-readable medium or from another device via the communication interface 170. When executed, software instructions stored in the memory 130 and/or the storage component 140 may cause the processor 120 to perform one or more processes described herein.

Additionally, or alternatively, hardwired circuitry may be used in place of, or in combination with, software instructions to perform one or more processes described herein. Thus, one or more example embodiments described herein are not limited to any specific combination of hardware circuitry and software.

The number and arrangement of components shown in FIG. 1 are provided as an example. In practice, the image synthesization device 100 may include additional components, fewer components, different components, or differently arranged components than those shown in FIG. 1. Additionally, or alternatively, a set of components (e.g., one or more components) of the image synthesization device 100 may perform one or more functions described as being performed by another set of components of the image synthesization device 100.

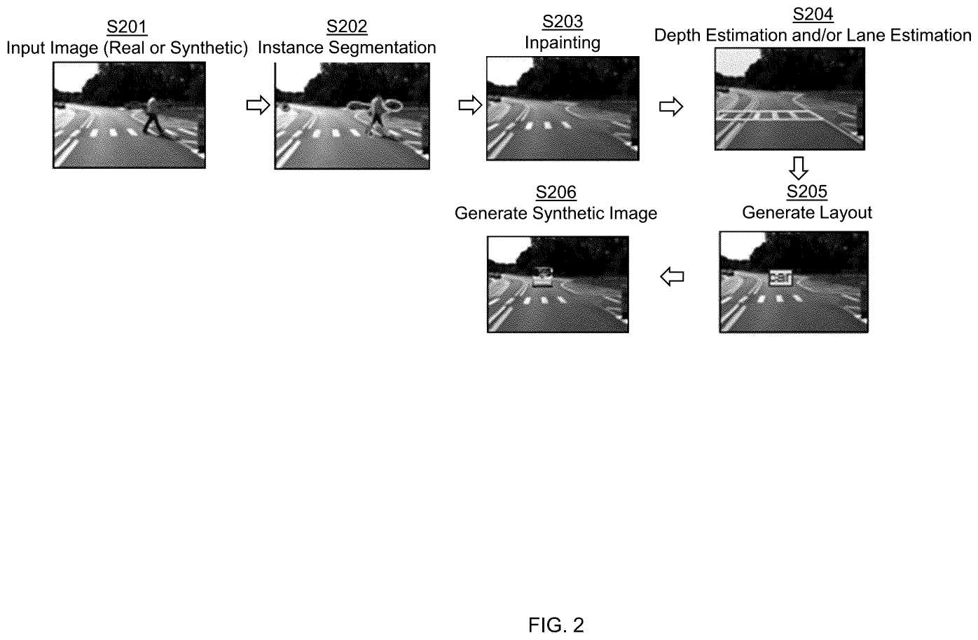

FIG. 2 is a flowchart diagram showing a method for generating a synthetic image by removing an unwanted object and generating a new synthetic object.

At operation S201, an input image (either a real image or a synthetic image) is provided. In particular, a method such as diffusion model may be used to obtain such an input image. Specifically, the diffusion model may allow for the user to generate a large amount of images as input data by using some text prompt. In the context of training/testing ML models for self-driving vehicles, this may include generating road images.

At operation S202, instance segmentation may be performed. In particular, there may be unwanted objects (such as foreground objects) which may not be useful for the test scenarios desired for the testing/training data. Accordingly, a pre-existing object may be removed from the input image using instance segmentation, which may detect the location of the pre-existing object and create a mask over it, so that the pre-existing object may be removed. In the example illustrated in FIG. 2, a pedestrian and other foreground objects may be selected and removed.

At operation S203, inpainting may be performed. Specifically, inpainting may fill in the region (the empty space) where the pre-existing object that was removed in operation S202. According to an embodiment, inpainting may be performed with a method such as by using a diffusion model. The empty area where the pre-existing object used to be may be inpainted to match the background. For example, as illustrated in FIG. 2, the background road is inpainted where the pedestrian used to be.

At operation S204, the position of other objects in the input image may need to be estimated, in order to use the estimated position to generate a layout. In the example illustrated in FIG. 2, this may include depth estimation and lane estimation. In some embodiments, the object may be a road structure object (for example, a road sign, road lanes, road region etc.). Accordingly, estimating the position may include estimating the depth of the road structure object. In an embodiment wherein the object is a road lane, estimating the position may include estimating the location of the road lane. As illustrated in FIG. 2, the position of the crosswalk and the position of the lanes may be determined.

At operation S205, a layout may be generated based on the estimated positions in operation S205. Particularly, the estimated position may be used as a criteria for where the synthetic object should be. As an example where the object is a road lane, the layout that is generated may use the positions of the road lane as horizontal bounds for the layout. As illustrated in FIG. 2, a layout for where a car should be generated is created.

At operation S206, a synthetic object may be generated. This can be done with a variety of image generation methods, such as by utilizing a diffusion model. As illustrated in the example of FIG. 2, a car may be generated based on the layout of operation S205.

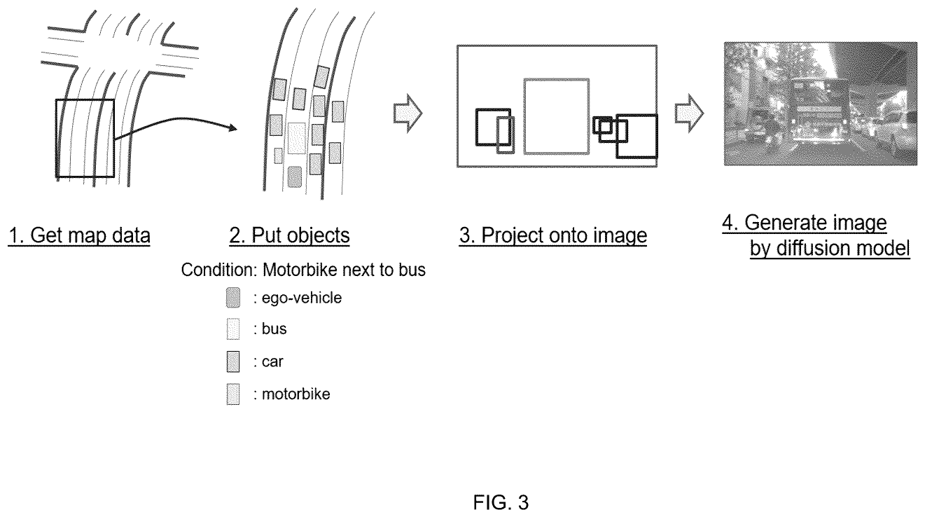

FIG. 3 is a flowchart diagram showing a method for generating an image based on road data using a diffusion model and bounding boxes.

In Step 1, road data may be obtained. This road data may be extracted from a map (e.g., based on a location input by a user, based on a location that is randomly determined, etc.) or may be generated (e.g., based on user-input or randomly determined parameters such as shape, number of lanes, etc.).

In step 2, locations of objects for an image to be generated are determined. Here, the locations of objects are determined with respect to the road data. Further, the locations of objects are determined based on one or more conditions (e.g., based on one or more of the input parameters that are user-input and/or randomly generated). The number, type, and placement of objects may be performed automatically based on the input parameters (e.g., the number of objects may correspond to an input number or may be randomly determined within an input number range). Examples of input parameters may include, but are not necessarily limited to, a particular scene configuration based on one or more conditions input by a user (e.g., motorbike at back of a truck, three people crossing a road, etc) and a user input distribution of distances of cars (e.g., non-ego vehicles) to the camera perspective (e.g., ego-vehicle) (e.g., 30%<20 m, 50%>=20 m, 20%>60 m).

Alternatively or additionally, a system for generating image data in accordance with one or more embodiments may output a user interface (such as a graphical user interface shown in step 2 of FIG. 3) by which a user may place the objects on the road data (e.g., by drag and drop, with different color objects corresponding to different types) or may modify an automatically determined placement of objects on the road data (e.g., by drag-and-drop, etc.). It should be appreciated that order methods to visualize the locations of the objects relative to the road data may also be used in order to allow the user to determine the location of the objects.

In step 3, object bounding boxes are projected onto an image plane based on the road data and the determined locations of objects with respect to the road data. Here, the image plane is of (or from the perspective of) an ego-vehicle's (autonomous driving machine's) camera. For example, the image plane and the projected objects may be generated automatically based on predefined camera parameters of an ego-vehicle. According to an embodiment, the system may output a graphical user interface visualizing the bounding boxes projected on the image plane. Here, different colors may be utilized for the bounding boxes, the different colors respectively corresponding to different object types (e.g., pedestrians, cars, trucks, motorcycles, vans, etc.). Further, in an example embodiment, a user may be able to modify the bounding boxes (e.g., by touch and drag to change the shape, or by a user operation to change the color/object type).

In step 4, an image is generated by a diffusion model using the object bounding poxes projected onto the image plane as an input. According to an embodiment, given a set of bounding boxes as conditioning, the diffusion model synthesizes images so that positions, sizes, and types of the target objects match the bounding boxes. Since using a diffusion model may result in random images for the target objects in the bounding boxes, the method may be repeated any number of times (e.g., user-input number of times) to generate different layouts from the same input parameters, and generate one or more images for each layout.

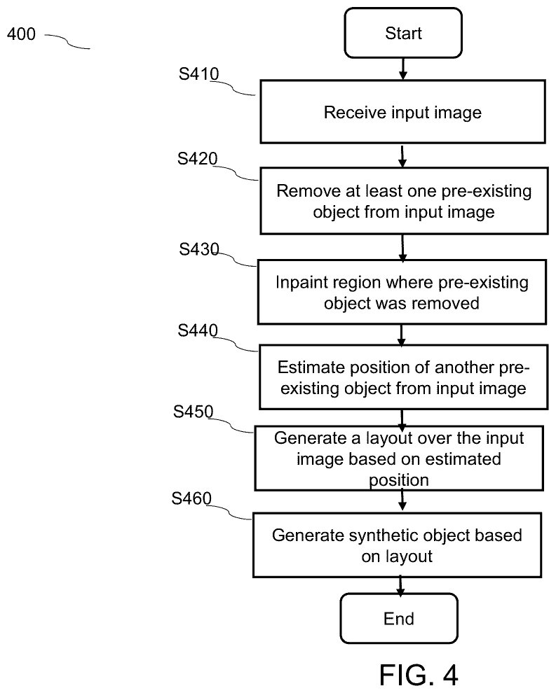

FIG. 4 is a flowchart diagram showing a method 400 for generating a synthetic image based on a layout. The method may be similar to the method illustrated in FIG. 2.

At operation S410, an input image (either a real or a synthetic image) may be received. This may be similar to operation S201 described with reference to FIG. 2 above.

At operation S420, at least one pre-existing object may be removed from the input image received in operation S410. The pre-existing object may be a foreground object in the input image. According to some embodiments, the removal of the object may be performed using instance segmentation. Operation S420 may be similar to operation S202 described with reference to FIG. 2 above.

At operation S430, the region where the at least one pre-existing object removed in operation S420 may be inpainted. This may be similar to operation S203 described with reference to FIG. 2 above.

At operation S440, the position of another pre-existing object in the input image may be estimated. This may include estimating the depth and/or the location. According to embodiments, the another pre-existing object may be a road structure object. The road structure object may be a road lane, and operation S440 may further include estimating the location of the road lane. This may be similar to operation S204 described with reference to FIG. 2 above.

At operation S450, a layout may be generated over the input image based on the estimated position of the another pre-existing object determined in operation S440. The layout may be represented in the form of a box or rectangle, or by a set of coordinates. It should also be appreciated that while the method exemplified above is described with reference to a single pre-existing object, multiple objects may be used simultaneously or consecutively for generating the layout. Operation S450 may be similar to operation S205 described with reference to FIG. 2 above.

At operation S460, the synthetic object may be generated in an image based on the layout generated in operation S450 above. According to embodiments, this may be performed using a diffusion model. According to embodiments, the synthetic object may be a vehicle. This may be similar to operation S206 described with reference to FIG. 2 above.

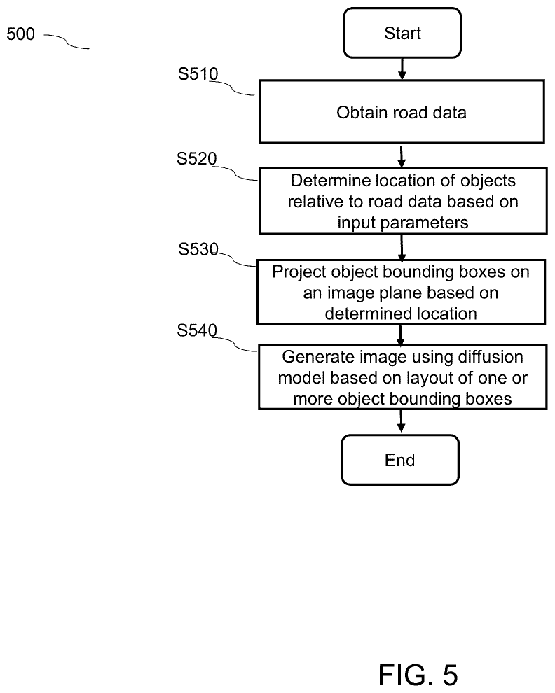

FIG. 5 is a flowchart diagram showing a method 500 for generating a synthetic image using a diffusion model. The method may be similar to the method illustrated in FIG. 3.

At operation S510, road data is received. The road data may be automatically generated based on location parameters input by a user, or it may be randomly determined. The road data may be based on a map and may also be represented with 3D data. This may be similar to step 1 described with reference to FIG. 3 above.

At operation S520, a location of one or more objects relative to the road data received in operation S510 may be determined based on one or more input parameters. According to embodiments, the input parameters may include, but are not limited to, at least one of a number of the one or more objects, an object type, information on a position relative to an ego-vehicle, location information for road data, and information on one or more relationships between objects. Determining the location may further comprise determining at least one of a number and object type of the one or more objects (e.g., a number of vehicles, a type of vehicles, etc.). This may be similar to step 2 described with reference to FIG. 3 above.

At operation S530, one or more object bounding boxes may be projected onto an image plane based on the determined location(s) in operation S520. The image plane may be from the perspective of a camera. Each object bounding box may correspond to one or more objects, and specify the location wherein the synthetic object should be generated. This may be similar to step 3 described with reference to FIG. 3 above.

At operation S540, an image is generated using the a diffusion model based on a layout of the one or more object bounding boxes from operation S530. This may be similar to step 4 described with reference to FIG. 3 above. It should be appreciated that operation S540 may be repeated multiple times in order to generate multiple images which fulfill the same input parameters that were provided.

By using a method which can remove unwanted objects from an input image and add synthetic objects based on a layout, testing/training data images can be generated with high quality. In addition, using a method which automatically projects a bounding box layout for a diffusion model based on one or more defined conditions (or input parameters), a large and robust training or testing image dataset for an AI/ML model can be generated automatically and efficiently. Accordingly, large amounts of high quality testing/training data images can be readily generated for the ML model.

The foregoing disclosure provides illustration and description, but is not intended to be exhaustive or to limit one or more example embodiments to the precise form disclosed. Modifications and variations are possible in light of the disclosure or may be acquired from practice of one or more example embodiments.

One or more example embodiments may relate to a system, a method, and/or a computer readable medium at any possible technical detail level of integration. Further, one or more of the components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In one or more example embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible example embodiments of systems, methods, and computer readable media according to one or more example embodiments. In this regard, each block in the flowchart or block diagrams may represent a microservice(s), module, segment, or portion of instructions, which comprises one or more executable instructions for implementing the specified logical function(s). The method, computer system, and computer readable medium may include additional blocks, fewer blocks, different blocks, or differently arranged blocks than those depicted in the drawings. In one or more alternative example embodiments, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of one or more example embodiments. Thus, the operation and behavior of the systems and/or methods were described herein without reference to specific software code—it being understood that software and hardware may be designed to implement the systems and/or methods based on the description herein.

What is claimed is:

1. A method for generating a synthetic image, the method comprising:
receiving an input image;
removing at least one pre-existing object from the input image;
inpainting the region where the at least one pre-existing object was removed;
estimating a position of another pre-existing object from the input image;
generating a layout over the input image based on the estimated position; and
generating a synthetic object based on the layout.

2. The method according to claim 1, wherein the at least one pre-existing object is a foreground object,
wherein the another pre-existing object is a road structure object; and
wherein the generated synthetic object is a vehicle.

3. The method according to claim 2, wherein estimating a position of the another pre-existing object comprises:
estimating the depth of the road structure object

4. The method according to claim 3, wherein the another pre-existing object is a road lane, and wherein
estimating a position of the another pre-existing object further comprises:
estimating the location of the road lane.

5. The method according to claim 4, wherein removing the at least one object is performed by instance segmentation.

6. A method for generating a synthetic image using a diffusion model, the method comprising:
obtaining road data;
determining a location of one or more objects relative to the road data, based on one or more input parameters;
projecting one or more object bounding boxes, corresponding to the one or more objects, on an image plane based on the determined location, the image plane being from a perspective of a camera; and
generating an image using a diffusion model based on a layout of the one or more object bounding boxes.

7. The method according to claim 6, wherein the road data is automatically generated based on location parameters input by a user or randomly determined.

8. The method according to claim 6, wherein the determining the location of the one or more objects comprises determining, based on the one or more input parameters, at least one of a number and object type of the one or more objects.

9. The method according to claim 6, wherein the one or more input parameters comprises at least one of a number of the one or more objects, an object type, information on a position relative to an ego-vehicle, location information for road data, and information on one or more relationships between objects.

10. The method according to claim 6, wherein the generating the image comprises generating, using the diffusion model, a plurality of images based on the layout.

11. An apparatus for generating a synthetic image, the apparatus comprising:
at least one memory storing computer-executable instructions; and
at least one processor configured to execute the computer-executable instructions to:
receive an input image;
remove at least one pre-existing object from the input image;
inpaint the region where the at least one pre-existing object was removed;
estimate a position of another pre-existing object from the input image;
generate a layout over the input image based on the estimated position; and
generate a synthetic object based on the layout.

12. The apparatus according to claim 11, wherein the at least one pre-existing object is a foreground object,
wherein the another pre-existing object is a road structure object; and
wherein the generated synthetic object is a vehicle.

13. The apparatus according to claim 13, wherein the at least one processor is further configured to execute the computer-executable instructions to estimate a position of the another pre-existing object by:
estimating the depth of the road structure object

14. The apparatus according to claim 13, wherein the another pre-existing object is a road lane, and wherein the at least one processor is further configured to execute the computer-executable instructions to estimate a position of the another pre-existing object by:
estimating the location of the road lane.

15. The apparatus according to claim 14, wherein removing the at least one object is performed by instance segmentation.

16. An apparatus for generating a synthetic image using a diffusion model, the apparatus comprising:
at least one memory storing computer-executable instructions; and
at least one processor configured to execute the computer-executable instructions to:
obtain road data;
determine a location of one or more objects relative to the road data, based on one or more input parameters;
project one or more object bounding boxes, corresponding to the one or more objects, on an image plane based on the determined location, the image plane being from a perspective of a camera; and
generate an image using a diffusion model based on a layout of the one or more object bounding boxes.

17. The apparatus according to claim 16, wherein the road data is automatically generated based on location parameters input by a user or randomly determined.

18. The apparatus according to claim 16, wherein the at least one processor is further configured to execute the computer-executable instructions to determine the location of the one or more objects by determining, based on the one or more input parameters, at least one of a number and object type of the one or more objects.

19. The apparatus according to claim 16, wherein the one or more input parameters comprises at least one of a number of the one or more objects, an object type, information on a position relative to an ego-vehicle, location information for road data, and information on one or more relationships between objects.

20. The apparatus according to claim 16, wherein the at least one processor is further configured to execute the computer-executable instructions to generate the image by generating, using the diffusion model, a plurality of images based on the layout.
